(19) United States
(12) Patent Application Publication
(10) Pub. No.: US 2012/0005676 A1
(43) Pub. Date: Jan. 5, 2012

(54) Computing Machine and Method of Updating Virtual Machine

(76) Inventor: Hiroshi Nakajima, Nishitokyo-shi (JP)

(21) Appl. No.: 13/094,690

(22) Filed: Apr. 26, 2011

(30) Foreign Application Priority Data
Jun. 30, 2010 (JP) 2010-150451

(51) Int. Cl. G06F 9/455

(52) U.S. Cl. 718/1

(57) ABSTRACT

According to one embodiment, a computing machine for executing a virtual machine, includes a restriction module. The restriction module is configured to restrict, in an update mode in which an operating system and/or an application program in the virtual machine are updated, an I/O device recognized by the virtual machine to a first I/O device which is necessary for executing the operating system and/or the application program.

### CROSS-REFERENCE TO RELATED APPLICATIONS

This application is based upon and claims the benefit of priority from prior Japanese Patent Application No. 2010-150451, filed Jun. 30, 2010; the entire contents of which are incorporated herein by reference.

### FIELD

Embodiments described herein relate generally to a computing machine on which a virtual machine is executed and a method of updating the virtual machine.

### BACKGROUND

Conventionally, in order to update at least part of an operating system and application software of a virtual machine, image data of the virtual machine is loaded from a storage device, the image data is activated by virtualized software on a server, an update program obtained via an I/O device emulator and an external communication I/O device are virtually performed, and software on the virtual machine image is rewritten.

Devices such as a disc and a network controller in each virtual machine are virtually embodied through device emulation provided by the virtualized software, and a plurality of virtual machines can be executed on one host. Actual data is stored in a storage device, but each virtual machine is accessed via a device emulator and via an external communication I/O device (network controller and a disc controller).

Since the I/O device is executed through emulation, the process of loading and activating image data of the virtual machine and writing the updated result will be slow. When several tens to several hundreds of virtual machines are provided, the virtual machines need to be activated and executed one by one, which places a load on the I/O device and takes much time to update all the virtual machine images. Further, a significant load will also be placed on the CPU that executes the virtual machine, which can incur increase in cost and consumption power of the hardware of the devices, if a plurality of servers are simultaneously executed, for example.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a block diagram illustrating an example of a system configuration of the embodiment.

FIG. 2 is a block diagram illustrating a configuration of a server of the embodiment.

FIG. 3 illustrates a procedure of updating an operating system and an application program in a virtual machine, according to the embodiment.

FIG. 4 is a flowchart illustrating a procedure of updating an operating system and an application program in the virtual machine.

### DETAILED DESCRIPTION

Various embodiments will be described hereinafter with reference to the accompanying drawings.

In general, according to one embodiment, a computing machine for executing a virtual machine includes a restriction module. The restriction module is configured to restrict, in an update mode in which an operating system and/or an application program in the virtual machine are updated, an I/O device recognized by the virtual machine to a first I/O device which is necessary for executing the operating system and/or the application program.

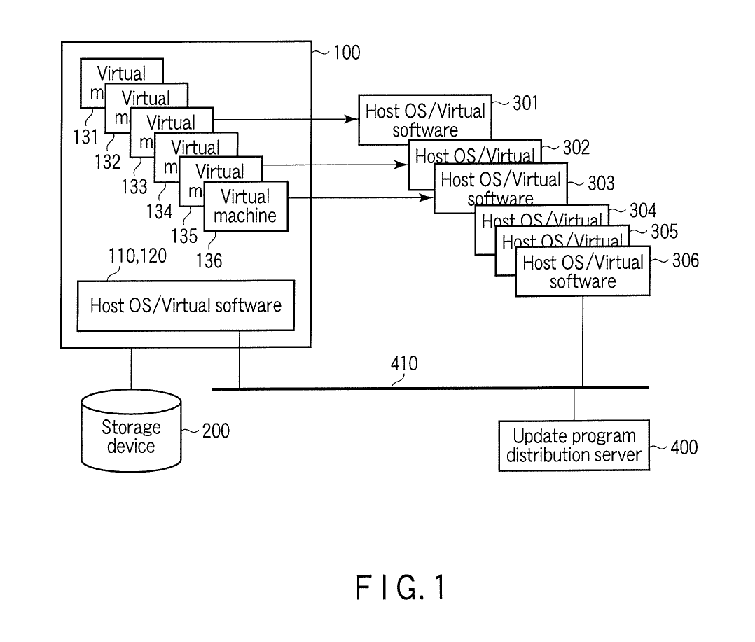

FIG. 1 is a block diagram illustrating a configuration of a virtualization system.

In a server 100 as a computing machine, a host operating system 110 designed to execute a virtual machine and virtualization software 120 executes. A storage device 200 stores execution image data (virtual machine image data) of the virtual machine. The virtual machine image data separately exists in each of the virtual machines 131-136. The execution result by each of the virtual machines 131-136 is transmitted via a LAN as data displayed on a screen and displayed on client terminals 301-306. Input/output of a key code, for example, input to the client terminals 301-306 is received and processed by the virtual machines 131-136.

Each of the virtual machines 131-136 receives an update program from an update program distribution server 400 via a network 410, and updates its image and application by executing the received update program.

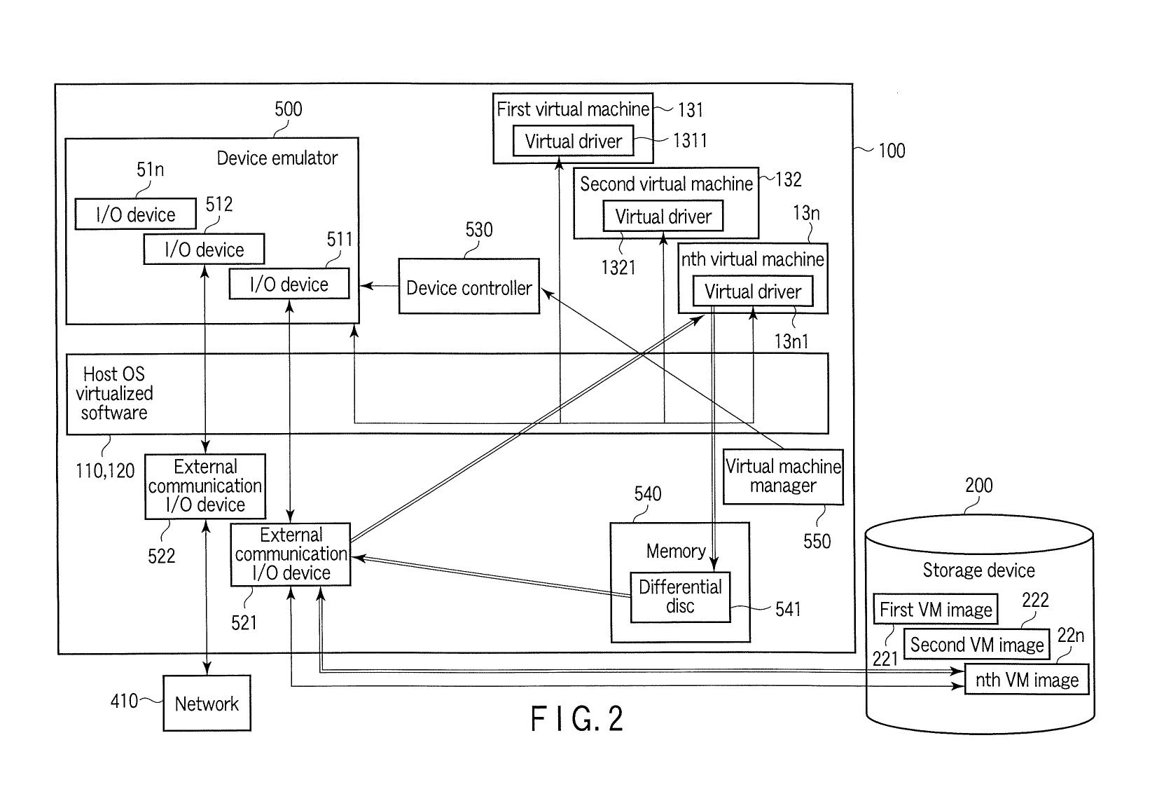

FIG. 2 is a block diagram illustrating a configuration of a server on which a virtual machine is executed.

The storage device 200 stores virtual machine image data 221, 222, . . . , 22n, used to execute virtual machines 131, 132, . . . , 13n, respectively. In the normal execution mode, the virtual machine 13n is executed using I/O devices 511, 512, . . . , 51n of a device emulator 510, and when communications need to be performed externally, accesses a storage device or a network via an actual communication I/O device (AT Attachment [ATA] controller) 521 and a communication I/O device (network controller) 522.

The device controller 530 controls the I/O device in the device emulator 520 between valid and invalid. When one I/O device is invalidated, the device cannot be recognized from the virtual machine.

In each of the virtual machines 131, 132, . . . , 13n, virtual disc drivers 1311, 1321, . . . , 13n1, used to access the storage device 200, are executed. Each of the virtual disc drivers 1311, 1321, . . . , 13n1 produces an output to a differential disc file 541 on a memory 540 when the virtual machines 131, 132, . . . , 13n write to the storage device 200. Further, data is read from the storage device 200 via the external communication I/O device 521 from the storage device 200. When the same written location is read, it is read from the differential disc file 541 on the memory.

The virtualization software 120 controls each of the virtual machines 131, 132, . . . , 13n between activation and stop and aquires the state thereof.

When an instruction to update the operating system and/or application in each of the virtual machine image is given from an application program executed under the host operating system 110, the virtualization software 120 defines the device controller 530 such that the I/O device is configured in an update mode. Upon receipt of an instruction to configure the update mode, the device controller 530 validates only the minim devices (network controller, virtual disc, standard display, keyboard, and the like) necessary for updating, and invalidates all the other I/O devices. In this state, the virtualization software 120 gives an instruction to activate the virtual machine 13n to the virtualization software 120, and thereby the virtual machine 13n is activated. In this activation, the activation disc is driven using the virtual disc driver 13n1. The virtual disc driver 13n1 performs data transmission/reception to and from the external communication I/O device 521 via the virtualization software 120, and acquires virtual machine image data 22n from the storage device 200.

Data written to the storage device 200 during the activation is not directly written to the storage device 200. Using the virtual hard disc and technology, a sector on the storage device 200 in which data is to be varied is recorded and data to be recorded in the sector is written to the differential disc file 541 on the memory.

After activation, the virtual machine 13n downloads an update program via the communication I/O device (network controller) 522 from the update program distribution server 300, and executes the program. All the data written to the storage device 200 by this execution is stored in the differential disc file 541 on the memory 540. After execution of the update program, the virtual machine 13n is shut down.

After the shutdown, the differential disc file 541 of the virtual machine image data 22n in the memory is transferred to the storage device 200 for storage, or a merge program executed under the host operating system 100 of the server 100 rewrites data of the virtual machine image according to the differential disc file 541. After this process is repeatedly performed on each of the virtual machines, update application is ended.

After the update, the virtualization software 120 returns the device controller 530 to the normal I/O mode via the virtualization software 120, such that all the I/O devices can be used. After that, the activated virtual machines are updated in a state where the normal I/O device is seen.

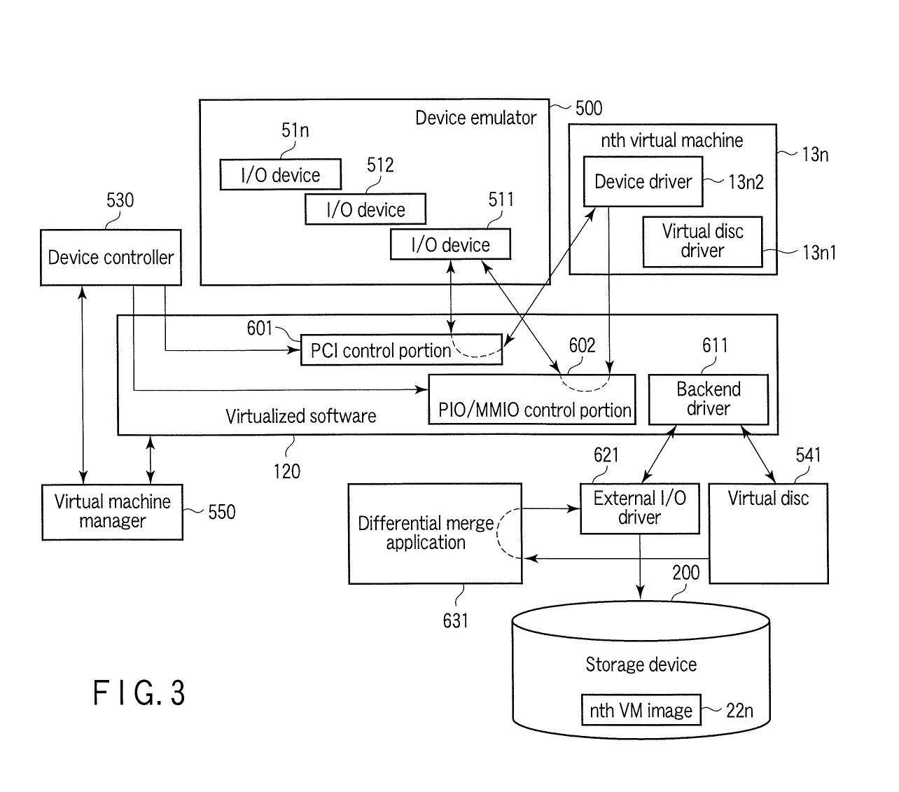

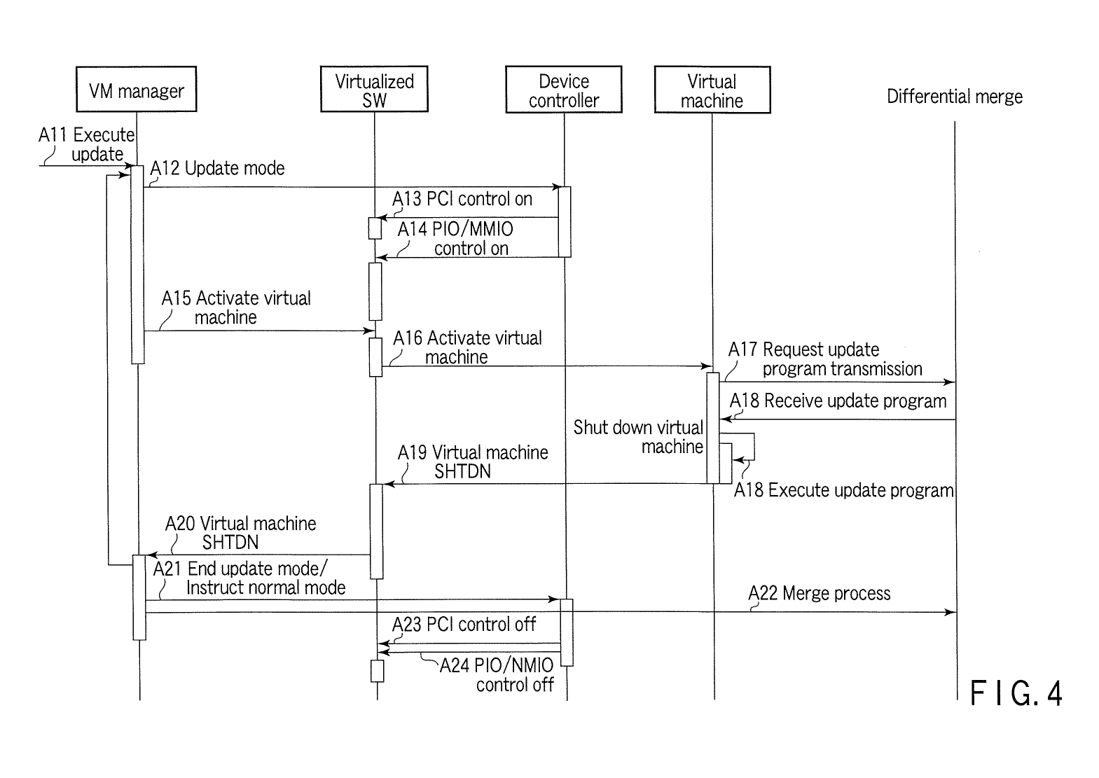

Next, the procedure for the process of updating an operating system and an application program in a virtual machine will be described with reference to FIGS. 3 and 4. FIG. 3 illustrates a process of updating an operating system and an application program in a virtual machine. Further, FIG. 4 is a flowchart illustrating the procedure for the process of updating an operating system and an application program in a virtual machine.

When the virtualization software 120 is notified of update execution (block A11), the virtualization software 120 notifies the device controller 530 of activation of the virtual machine 13n in an update mode (block A12). The device controller 530 gives an instruction to start restricting the PCI device to the virtualization software 120 (block A13). Further, the device controller 530 gives an instruction to start restricting a programmed input/output (PIO) device and a memory-mapped input/output (MMIO) device to the virtualization software 120 (block A14). The virtualization software 120 is set such that access from only specific devices that are necessary for the PCI control portion 601 and the PIO/MMIO control portion 602 are allowed to pass through. The PCI control portion 601 monitors access to the PCI configuration resistor, and interrupts all the accesses except those from the virtual machine 13n and to a PIC device that is necessary in the update mode. As a result thereof, the virtual machine 13n will not recognize existence of the PCI device. Further, the PIO/MMIO control portion 602 does not pass data to I/O devices other than specific ones that are allowed. Thus, since the virtual machine 13n do not recognize existence of devices other than those necessary for execution in the update mode and such devices do not need to be subjected to an initialization process, the virtual machine 13n can be activated at a higher rate than the conventional technique.

The virtual software 120 gives an instruction to activate the virtual machine 13n to the virtualization software 120 (block A15). The virtualization software 120 activates the virtual machine 13n according to an instruction from the virtualization software 120 (block A16). The virtualization machine 13n performs disc access using the virtualization disc driver 13n1, and performs activation. In that case, the conventional I/O device bypasses the conventional I/O device, and a backend driver 611 in the virtualization software 120 receives the disc request and access the actual driver 621 to the external storage device. When a disc write request is received, data is written to the differential disc file 541 arranged on the main memory. When a read request is received, data is acquired from the external storage device 200.

When update of the virtual machine 13n is ended, the virtualization software 120 detects end of the update and causes the virtualization software 120 to end the virtual machine 13n. After the virtual machine 3n has ended (blocks A19, 20), the virtualization software 120 notifies the device controller 530 of end of the update mode and start of the normal mode (block A21).

When update is applied to the virtual machine image data 22n in the storage device 200, the virtualization software 120 merges a differential image of the differential disc file 541 on the memory and the virtual machine image data 22n in the storage device 200 by sector unit, using the differential merge application program (differential application) 631 executed under a host OS 110 (block A22).

The device controller 530 instructs the PCI control portion 601 and the PIO/MMIO control portion 602 to end the PCI control and the PIO/MMIO control (blocks A23, 24).

Through the above-described processes, the update time will be decreased by merging all the updated images simultaneously, compared to the conventional update using an update program executed by a virtual machine. Further, since the I/O emulator of the disc is bypassed, the access properties of the disc are improved and the update program is executed in this state, and since a memory will be accessed in order to write data, and the CPU load will be reduced by equal to or more than 30%, compared to the conventional update.

It is to be noted that the update may be performed by a client computer.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A computing machine for executing a virtual machine, comprising:
a restriction module configured to restrict, in an update mode in which an operating system and/or an application program in the virtual machine are updated, an I/O device recognized by the virtual machine to a first I/O device which is necessary for executing the operating system and/or the application program.

2. The computing machine of claim 1, wherein the first I/O device comprises a PCI device, a PIO device which is accessed by PIO access, and a MMIO device which is accessed by MMIO access.

3. The computing machine of claim 1, further comprising:
a main memory;
a write module configured to write modified data and modified portion data indicating a modified portion to be modified in the virtual machine to a virtual disc in the main memory in the update mode; and
a modification module configured to modify an image data of the virtual machine based on the modified data and modified portion data.

4. The computing machine of claim 1, wherein a plurality of second virtual machines comprising the virtual machine execute on the computing machine.

5. A method of updating a virtual machine in a computing machine on which the virtual machine is executed, comprising:
restricting, in an update mode in which the virtual machine updates an operating system and/or an application program, an I/O device recognized by the virtual machine to a first I/O device which is necessary for executing the operating system and/or the application program.

6. The method of claim 5, further comprising:
writing modified data and modified portion data indicating a portion to be modified in the virtual machine to a virtual disc in a main memory in the update mode; and
modifying image data of the virtual machine based on the modified data and the modified portion data.
